(19) United States
(12) Patent Application Publication
(10) Pub. No.: US 2015/0272088 A1
(43) Pub. Date: Oct. 1, 2015

(54) Caddy Assembly

(71) Applicant: Clinton E. Woodward, Tempe, AZ (US)

(72) Inventor: Clinton E. Woodward, Tempe, AZ (US)

(21) Appl. No.: 14/224,189

(22) Filed: Mar. 25, 2014

(51) Int. Cl. A01K 63/00; A47B 81/00; A47B 81/06; A01K 63/04

(52) U.S. Cl. CPC A01K 63/006; A01K 63/003; A01K 63/042; A01K 63/047; A47B 81/00; A47B 81/06

(57) ABSTRACT

A caddy assembly for supporting an aquarium and a display includes a housing that may be positioned on a support surface. An L-shaped support is coupled between a bottom wall and a top wall of the housing. The top wall of the housing may support an aquarium. A shelf is coupled between the bottom and top walls of the housing. A display support is coupled to the housing. The display support extends upwardly from the housing. A mount is coupled to the display support so the mount may support a display. A pump is coupled to the housing. The pump is operationally coupled to the aquarium so the pump urges a fluid into the aquarium. A trough coupled to the housing. The trough may capture fluid from the aquarium. A drain is coupled to the housing. The drain is operationally coupled to the trough so the drain collects the fluid.

### BACKGROUND OF THE DISCLOSURE

### Field of the Disclosure

The disclosure relates to caddy devices and more particularly pertains to a new caddy device for supporting an aquarium and a display.

### SUMMARY OF THE DISCLOSURE

An embodiment of the disclosure meets the needs presented above by generally comprising a housing that may be positioned on a support surface. The housing comprises an L-shaped support coupled between a bottom wall and a top wall of the housing. The top wall of the housing may support an aquarium. A shelf is coupled between the bottom wall and the top wall of the housing. The shelf may support an item. A display support is coupled to the housing. The display support extends upwardly from the housing. A mount is coupled to the display support so the mount may support a display. A pump is coupled to the housing. The pump is operationally coupled to the aquarium so the pump urges a fluid into the aquarium. A trough is coupled to the housing. The trough may capture fluid from the aquarium. A drain is coupled to the housing. The drain is operationally coupled to the trough so the drain collects the fluid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a caddy assembly according to an embodiment of the disclosure.

FIG. 2 is a bottom view of an embodiment of the disclosure.

FIG. 3 is a back view of an embodiment of the disclosure.

FIG. 4 is a right side view of an embodiment of the disclosure.

FIG. 5 is a perspective view of an embodiment of the disclosure.

### DESCRIPTION OF THE PREFERRED EMBODIMENT

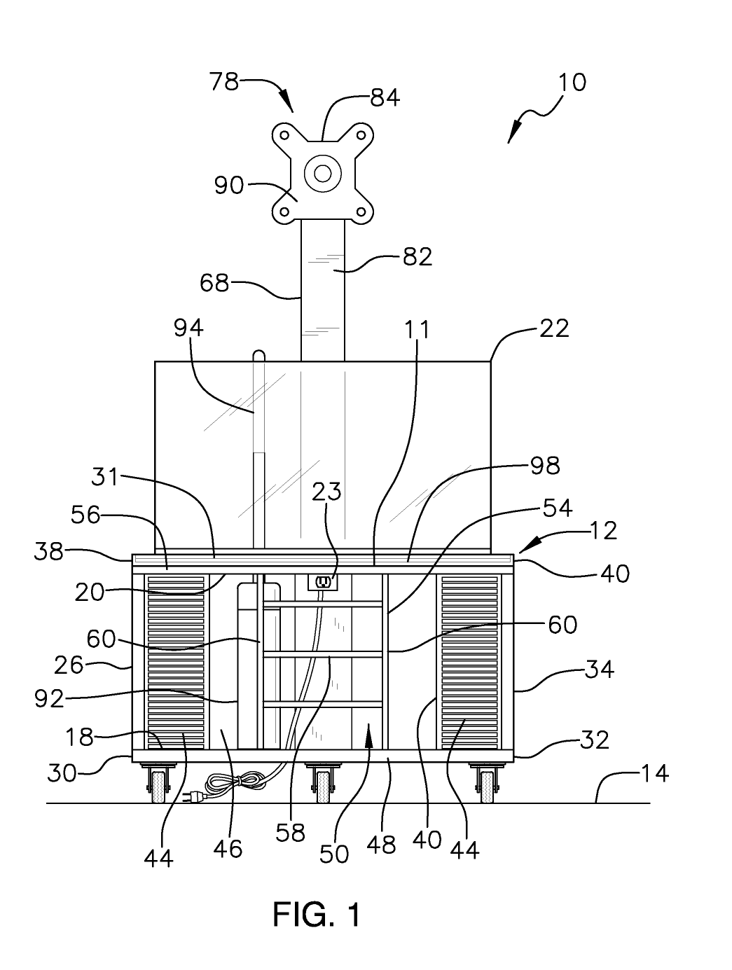

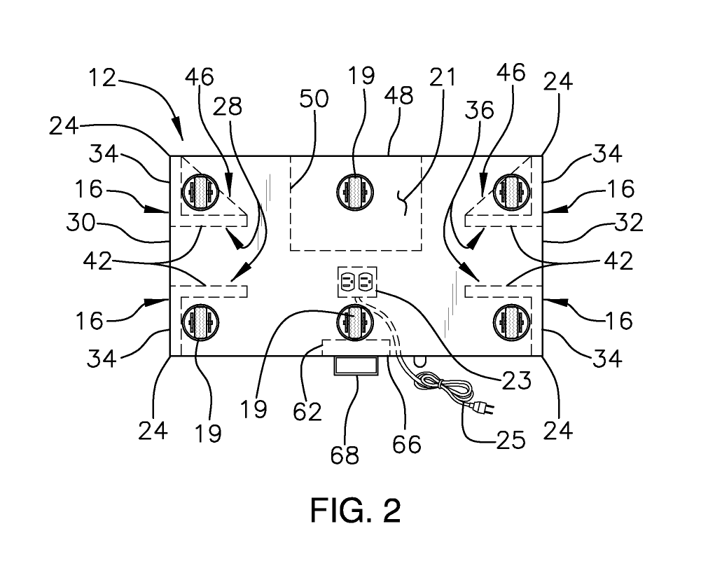

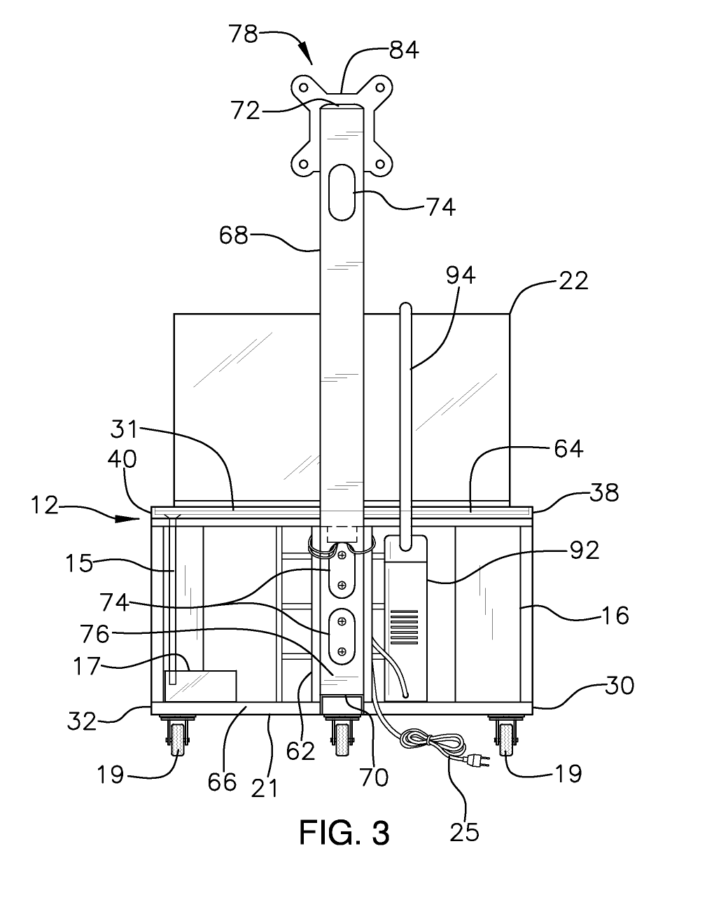

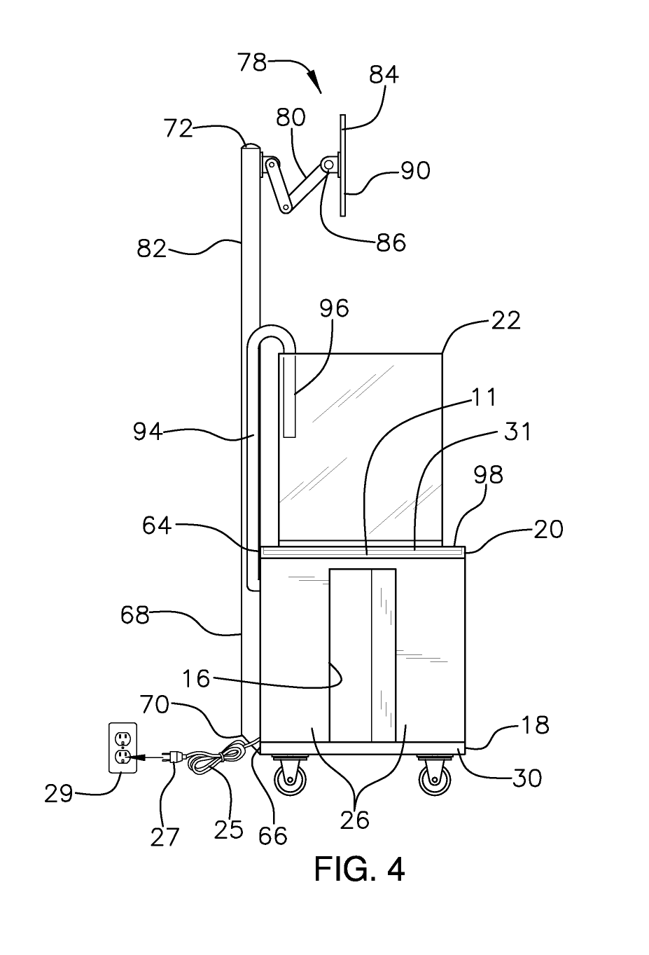

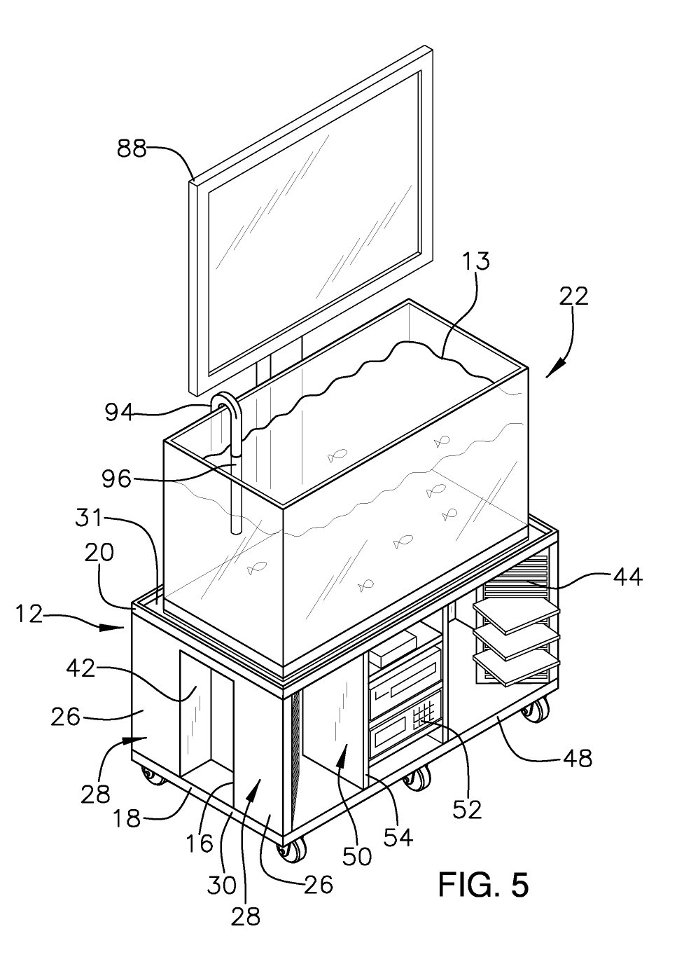

With reference now to the drawings, and in particular to FIGS. 1 through 5 thereof, a new caddy device embodying the principles and concepts of an embodiment of the disclosure and generally designated by the reference numeral 10 will be described.

As best illustrated in FIGS. 1 through 5, the caddy assembly 10 generally comprises a housing 12 that may be positioned on a support surface 14. The housing 12 has a width that is greater than a depth of the housing 12. Moreover, the housing 12 has a rectangular shape that may have a width between 90 cm and 122 cm, a depth between 60 cm and 70 cm and a height between 60 cm and 70 cm. An L-shaped support 16 is coupled between a bottom wall 18 and a top wall 20 of the housing 12. The top wall 20 of the housing 12 may support an aquarium 22.

A pad 31 is positioned on a top surface 11 of the top wall 20 of the housing 12. The pad 31 completely covers the top wall 20 of the housing 12. The aquarium 22 rests on the pad 31. The pad 31 may be comprised of a resiliently compressible material such as rubber of other similar material. Lastly, the pad 31 prevents the aquarium 22 from transferring a vibration into the housing 12.

The L-shaped support 16 is one of a plurality of the L-shaped supports 16. Each of the plurality of L-shaped supports 16 is positioned proximate and extending between an associated one of four corners 24 of each of the top 20 and bottom 18 walls of the housing 12. A first lateral side 26 of each of a first set of the plurality of L-shaped supports 28 is coextensive with an associated one of a first lateral edge 30 and a second lateral edge 32 of the bottom wall 18 of the housing 12. Continuing, a first lateral side 34 of each of a second set of the plurality of L-shaped supports 36 is coextensive with an associated one of a first lateral edge 38 and a second lateral edge 40 of the top wall 20 of the housing 12. In addition, a second lateral side 42 of each of the plurality of L-shaped supports 16 is directed inwardly from the associated one of the first 30, 38 and second 32, 40 lateral edges of each of the top 20 and bottom 18 walls of the housing 12. Each of the first 26, 34 and second 42 lateral sides of each of first 28 and second 36 sets of the plurality of L-shaped supports may have a width between 10 cm and 15 cm.

A pair of CD racks 44 is coupled between the first 26, 34 and second 42 lateral sides of a front one of each of the first and second sets of L-shaped supports 46. The pair of CD racks 44 extends between the bottom wall 18 and the top wall 20 of the housing 12. Additionally, each of the CD racks 44 forms an acute angle with respect to a front edge 48 of the bottom wall 18 of the housing 12. Further, the pair of CD racks 44 may support a plurality of CD's or DVD's.

A shelf 50 is coupled between the bottom wall 18 and the top wall 20 of the housing 12. The shelf 50 may support an item 52. Further, the item 52 may be an electronic entertainment device of any conventional design. A front edge 54 of the shelf 50 is coextensive with a front edge 56 of the top wall 20 of the housing 12 and the front edge 48 of the bottom wall 18 of the housing 12. A plurality of horizontal walls of the shelf 58 is each coupled between a pair of vertical walls of the shelf 60. Moreover, the plurality of horizontal walls of the shelf 58 is evenly distributed between the top 20 and bottom 18 walls of the housing 12.

A secondary support 62 is coupled between the top 20 and bottom 18 walls of the housing 12. The secondary support 62 is positioned proximate a back edge 64 of the top wall 20 of the housing 12 and a back edge 66 of the bottom wall 18 of the housing 12. A display support 68 is coupled to the back edge 64 of the top wall 20 of the housing 12 and the back edge 66 of the bottom wall 18 of the housing 12. Moreover, the display support 68 may have a length between 150 cm and 180 cm.

The display support 68 has a hollow, rectangular shape. A bottom end 70 of the display support 68 is positioned proximate the bottom wall 18 of the housing 12. Moreover, a top end 72 of the display support 68 is positioned above the top wall 20 of the housing 12. A plurality of access apertures 74 extends through a back side 76 of the display support 68 to access an interior of the display support 68.

A mount 78 is provided. The mount 78 comprises an articulated arm 80 coupled to and extending laterally away from a front side 82 of the display support 68 proximate the top end 72 of the display support 68. The articulated arm 80 is movable in a plurality of directions with respect to the display support 65. A plate 84 is coupled to a free end 86 of the articulated arm 80. Continuing, a display 88 may be coupled to a front side 90 of the plate 84. The display 88 may be a flat screen television of any conventional design. Moreover, the display 88 is supported above the top wall 20 of the housing 12 and above the aquarium 22.

A pump 92 is coupled to the bottom wall 18 of the housing 12 proximate the back edge 66 of the bottom wall 18 of the housing 12. The pump 92 may be a fluid filter of any conventional design. The fluid may comprise water. The pump 92 filters the fluid in the aquarium 22 so the fluid may support aquatic life. Continuing, an fluid tube 94 is fluidly coupled to between the pump 92 and the aquarium 22 so the pump 92 urges the fluid into the aquarium 22. The fluid tube 94 is J-shaped so an upper portion 96 of the fluid tube 94 extends downwardly into the aquarium 22.

A trough 98 is coupled to the top surface 11 of the top wall 20 of the housing 12 proximate the front edge 56 of the top wall 20 of the housing 12. The trough 98 may capture fluid 13 that is spilled from the aquarium 22. Moreover, the fluid 13 may be water. A drain 15 is fluidly coupled between the trough 98 and a fluid container 17 positioned on the bottom wall 18 of the housing 12. The drain 15 is positioned proximate the fluid container 17 so the drain 15 may direct the fluid 13 into the fluid container 17.

A wheel 19 is rotatably coupled to a bottom surface 21 of the bottom wall 18 of the housing 12. The wheel 19 may be locking rubber caster of any conventional design. The wheel 19 may be locked so the wheel 19 does not roll. The wheel 19 may further be locked to the wheel 19 rolls only in a selected direction. Further, the wheel 19 may roll along the support surface 14. Continuing, the wheel 19 is one of a plurality of the wheels 19 that is evenly distributed along the front edge 48 and the back edge 66 of the bottom wall 18 of the housing 12.

A power supply 23 is coupled to the display support 68. The power supply 23 may be a power strip of any conventional design. Additionally, the pump 92, the display 88 and the items 52 on the shelf 50 may be selectively electrically coupled to the power supply 23. A power cord 25 is electrically coupled to and extends away from the power supply 23. Further, a plug end 27 of the power cord 25 is selectively electrically coupled to a power source 29. The power source 29 may be an electrical outlet of any conventional design.

In use, the aquarium 22 is positioned on the top wall 20 of the housing 12 and utilized in the convention of aquatic aquariums. The display 88 is coupled to the plate 84 so the display 88 is visible above the aquarium 22. Additionally, when the fluid container 17 becomes full, the fluid container 17 is removed and emptied. The assembly 10 may be utilized with only the aquarium 22, only the display 88 or with both the aquarium 22 and the display 88.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A caddy assembly for supporting an aquarium and a display, said assembly comprising:
a housing configured to be positioned on a support surface, said housing comprising;
an L-shaped support coupled between a bottom wall and a top wall of said housing wherein said top wall of said housing is configured to support the aquarium;
a shelf coupled between said bottom wall and said top wall of said housing wherein said shelf is configured to support an item;
a display support coupled to said housing wherein said display support extends upwardly from said housing;
a mount coupled to said display support wherein said mount is configured to support the display;
a pump coupled to said housing, said pump being operationally coupled to the aquarium wherein said pump urges a fluid into the aquarium;
a trough coupled to said housing wherein said trough is configured to capture fluid from the aquarium; and
a drain coupled to said housing, said drain being operationally coupled to said trough wherein said drain collects the fluid.

2. The assembly according to claim 1 further comprising said housing having a width being greater than a depth of said housing wherein said housing has a rectangular shape.

3. The assembly according to claim 1 further comprising said L-shaped support being one of a plurality of said L-shaped supports.

4. The assembly according to claim 1 further comprising:
each of a plurality of L-shaped supports being positioned proximate and extending between an associated one of four corners of each of said top and bottom walls of said housing;
a first lateral side of each of said plurality of L-shaped supports being coextensive with an associated one of a first lateral edge and a second lateral edge of said bottom wall of said housing and an associated one of a first lateral edge and a second lateral edge of said top wall of said housing; and
a second lateral side of each of said plurality of L-shaped supports being directed inwardly from the associated one of the first and second lateral edges of each of said top and bottom walls of said housing.

5. The assembly according to claim 1 further comprising a front edge of said shelf being coextensive with a front edge of said top wall of said housing and a front edge of said bottom wall of said housing.

6. The assembly according to claim 1 further comprising said shelf comprising a plurality of horizontal walls of said shelf each coupled between a pair of vertical walls of said shelf wherein said plurality of horizontal walls of said shelf is evenly distributed between said top and bottom walls of said housing.

7. The assembly according to claim 1 further comprising a secondary support coupled between said top and bottom walls of said housing wherein said secondary support is positioned proximate a back edge of said top wall of said housing and a back edge of said bottom wall of said housing.

8. The assembly according to claim 1 further comprising said display support being coupled to a back edge of said top wall of said housing and a back edge of said bottom wall of said housing wherein a bottom end of said display support is positioned proximate said bottom wall of said housing wherein a top end of said display support is positioned above said top wall of said housing.

9. The assembly according to claim 1 further comprising said mount comprising an articulated arm coupled to and extending laterally away from a front side of said display support proximate a top end of said display support.

10. The assembly according to claim 1 further comprising said mount further comprising a plate coupled to a free end of an articulated arm wherein said plate is configured to have the display coupled thereon wherein the display is supported above said top wall of said housing.

11. The assembly according to claim 1 further comprising:
said pump being coupled to said bottom wall of said housing proximate a back edge of said bottom wall of said housing; and
a fluid tube fluidly coupled to between said pump and the aquarium wherein said pump urges the fluid into the aquarium.

12. The assembly according to claim 1 further comprising said trough being coupled to a top surface of said top wall of said housing proximate a front edge of said top wall of said housing.

13. The assembly according to claim 1 further comprising said drain being fluidly coupled between said trough and a fluid container positioned on said bottom wall of said housing wherein said drain directs the fluid into said fluid container.

14. The assembly according to claim 1 further comprising a wheel rotatably coupled to a bottom surface of said bottom wall of said housing wherein said wheel is configured to roll along the support surface.

15. The assembly according to claim 14 further comprising said wheel being one of a plurality of said wheels being evenly distributed along a front edge and a back edge of said bottom wall of said housing.

16. The assembly according to claim 1 further comprising:
a power supply coupled to said display support;
said pump and said display being selectively electrically coupled to said power supply;
a power cord electrically coupled to and extending away from said power supply; and
a plug end of said power cord being selectively electrically coupled to a power source.

17. A caddy assembly for supporting an aquarium and a display, said assembly comprising:
a housing configured to be positioned on a support surface, said housing having a width being greater than a depth of said housing wherein said housing has a rectangular shape, said housing comprising;
an L-shaped support coupled between a bottom wall and a top wall of said housing wherein said top wall of said housing is configured to support the aquarium, said L-shaped support being one of a plurality of said L-shaped supports;
each of said plurality of L-shaped supports being positioned proximate and extending between an associated one of four corners of each of said top and bottom walls of said housing;
a first lateral side of each of said plurality of L-shaped supports being coextensive with an associated one of a first lateral edge and a second lateral edge of said bottom wall of said housing and an associated one of a first lateral edge and a second lateral edge of said top wall of said housing, a second lateral side of each of said plurality of L-shaped supports being directed inwardly from the associated one of the first and second lateral edges of each of said top and bottom walls of said housing;
a shelf coupled between said bottom wall and said top wall of said housing wherein said shelf is configured to support an item, a front edge of said shelf being coextensive with a front edge of said top wall of said housing and a front edge of said bottom wall of said housing, said shelf comprising;
a plurality of horizontal walls of said shelf each coupled between a pair of vertical walls of said shelf wherein said plurality of horizontal walls of said shelf is evenly distributed between said top and bottom walls of said housing;
a secondary support coupled between said top and bottom walls of said housing wherein said secondary support is positioned proximate a back edge of said top wall of said housing and a back edge of said bottom wall of said housing;
a display support coupled to said back edge of said top wall of said housing and said back edge of said bottom wall of said housing wherein a bottom end of said display support is positioned proximate said bottom wall of said housing wherein a top end of said display support is positioned above said top wall of said housing;
a mount comprising an articulated arm coupled to and extending laterally away from a front side of said display support proximate said top end of said display support, said mount further comprising;
a plate coupled to a free end of said articulated arm wherein said plate is configured to have the display coupled thereon wherein the display is supported above said top wall of said housing and above the aquarium;
a pump coupled to said bottom wall of said housing proximate said back edge of said bottom wall of said housing;
a fluid tube fluidly coupled to between said pump and the aquarium wherein said pump urges the fluid into the aquarium;
a trough coupled to a top surface of said top wall of said housing proximate said front edge of said top wall of said housing wherein said trough is configured to capture fluid from the aquarium;
a drain fluidly coupled between said trough and a fluid container positioned on said bottom wall of said housing wherein said drain directs the fluid into said fluid container;
a wheel rotatably coupled to a bottom surface of said bottom wall of said housing wherein said wheel is configured to roll along the support surface, said wheel being one of a plurality of said wheels being evenly distributed along said front edge and said back edge of said bottom wall of said housing; and
a power supply coupled to said display support, said pump and said display being selectively electrically coupled to said power supply; and
a power cord electrically coupled to and extending away from said power supply, a plug end of said power cord being selectively electrically coupled to a power source.
